(19) United States
(12) Patent Application Publication
(10) Pub. No.: US 2020/0085192 A1
(43) Pub. Date: Mar. 19, 2020

(54) MULTIFUNCTIONAL FURNITURE MODULE

(71) Applicant: QUADRIFOGLIO PARTNERS INC, Orlando, FL (US)

(72) Inventor: Felipe Peres WARTCHOW, Orlando, FL (US)

(73) Assignee: QUADRIFOGLIO PARTNERS INC

(21) Appl. No.: 16/131,715

(22) Filed: Sep. 14, 2018

(51) Int. Cl. A47B 96/20; A47B 47/00; F16B 12/02; F16B 12/26

(52) U.S. Cl. CPC A47B 96/201; A47B 47/0091; F16B 12/26; F16B 12/02; A47B 96/205

(57) ABSTRACT

A multifunctional furniture module is described, equipped with a connector with free ends with a linear recess where a fixed pin is fitted into the side faces of a plate, such pin sliding in a guided manner and being stopped by engaging a lid on the connector body, thus eliminating slacks and ensuring the structuring and finishing of the piece, such connector allowing for the multifunctionality and customization of the set, providing opportunity for altering the plates, connectors and lids, which may feature variations in textures and colors, among others, allowing for countless aesthetic combinations, apart from making the dismantling process easier, without damaging the structures, unlike the state-of-the-art solution, which require a number of steps, including the formation of holes and projections, requiring specific tools, as well as a set of operations for the assembly, which requires the alignment of the projection with the drilling and even so, at times results in a misaligned assembly of the adjacent plates.

### FIELD OF THE INVENTION

The present invention patent describes a multifunctional furniture module equipped with a connector with free ends with a linear recess where a fixed pin is fitted into the side faces of a plate, such pin sliding in a guided manner and being stopped by engaging a lid on the connector body, thus ensuring the locking of a pair of plates in order to form countless module variations for furniture application.

### BACKGROUND OF THE INVENTION

Furniture designs are increasingly providing concepts for multifunctionality and simplified assembly, meeting a market demand for simple parts with multiple uses that can be assembled by the user, in order to facilitate logistic operations.

However, when these furniture parts are assembled, they feature horizontal and vertical parts connected among themselves, forming a sharp corner, causing risk of injury and often having covers applied on them to prevent accidents. Examples of these constructions are contained in the document ES2650370, which describes “T” or “L”-shaped connection elements connecting a horizontal panel to a vertical panel featuring at least one recess to receive a part of the connection elements in a cavity. Document CA2838286 describes a bar with perforations on its main face and secondary face which are aligned with perforations on vertical and horizontal panels, such bar ensuring the attachment of these panels.

In order to provide better aesthetic and safety aspects, furniture designs have been featuring curved connectors to connect horizontal and vertical panels.

Document WO2016076783 describes a furniture connecting piece including a central curved corner section, a first connection disposition in first end of the central curved corner section and adapted for connection to a first piece of furniture and a second connection disposition in a second end of the curved corner section, whose second end is opposite to the first end and adapted for connection to a second piece of furniture.

Document US20040217678 describes a flat piece and a curved connecting member that are engaged and connected by means of projections that engage in perforations on the fitting piece on the end opposite to a rack with curved edges in various combinations.

However, these state-of-the-art connectors demand a number of steps including the formation of holes and projections, requiring specific tools, as well as a set of operations for the assembly, which requires the alignment of the projection with the drilling and often provides a misaligned assembly of the adjacent plates.

Thus, the purpose of this invention patent is a multifunctional furniture module equipped with a connector with free ends with a linear recess where a fixed pin is fitted into the side faces of a plate, such pin sliding in a guided manner and being stopped by engaging a lid on the connector body, thus eliminating slacks and ensuring the structuring and finishing of the piece, such connector allowing for the multifunctionality and customization of the set, providing opportunity for altering the plates, connectors and lids, which may feature variations in textures and colors, among others, allowing for countless aesthetic combinations, apart from making the dismantling process easier, without damaging the structures.

### BRIEF DESCRIPTION OF FIGURES

FIG. 1A shows a perspective view of a module featuring a fixed curved connector between a horizontal flat plate and a vertical flat plate, FIG. 1B shows a cross-sectional view and FIG. 1C presents a perspective view of a module featuring a fixed curved connector between two flat plates placed in parallel.

FIG. 2A presents a cross-sectional view of the connector and FIG. 2B presents a cross-sectional view of the connector equipped with an elastic flange.

FIG. 3 shows a broken-down view showing the connector and the pin to be attached to the flat plate.

FIG. 4 presents a cross-sectional view of a curved connector fixed between two plates.

FIG. 5A presents a perspective view of the lid and FIG. 5B presents a side view.

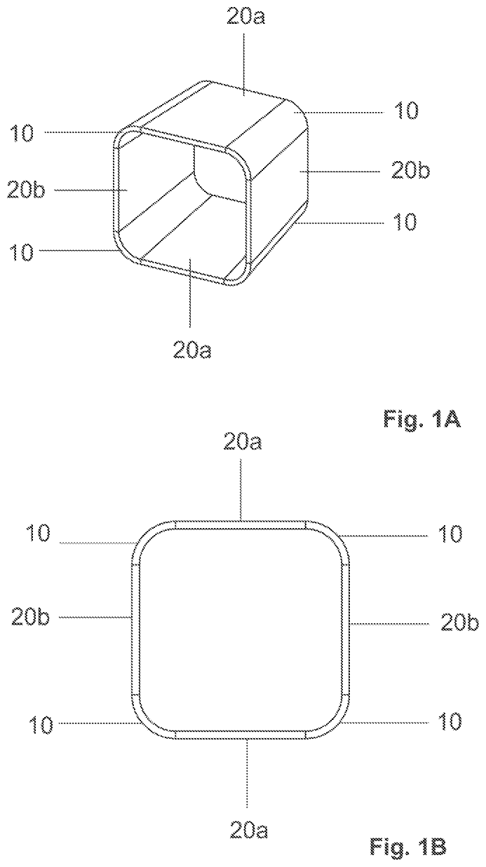

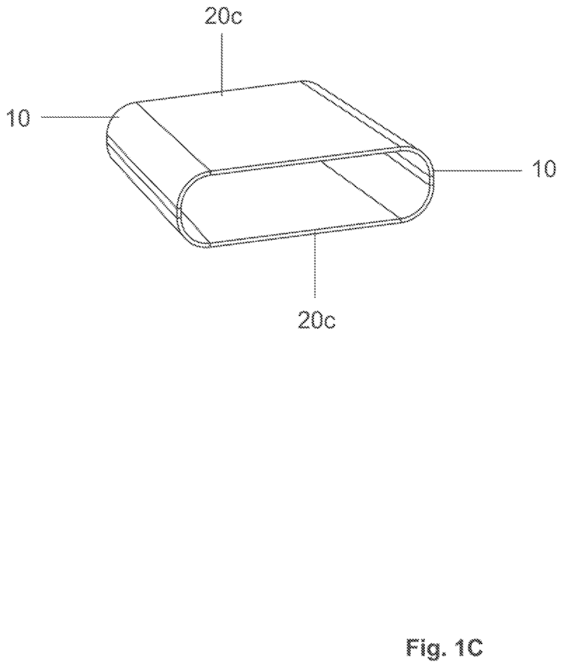

### DETAILED DESCRIPTION OF THE INVENTION

The multifunctional furniture model which is the object of this invention patent includes a connector, curved or otherwise (10), place between two plates, such a first plate placed horizontally (20a) and a second plate place vertically (20b), or between two plates placed in parallel (20c) and the connector's free ends (10) are fitted into a fixed pin on the side faces of the plates (20a, 20b or 20c).

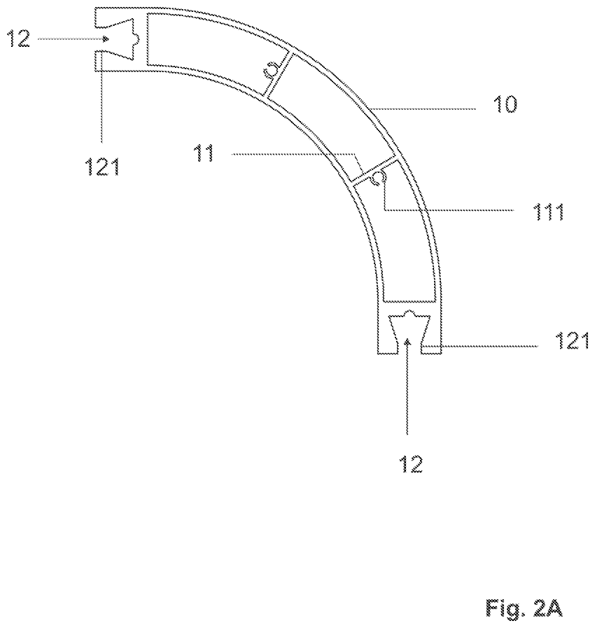

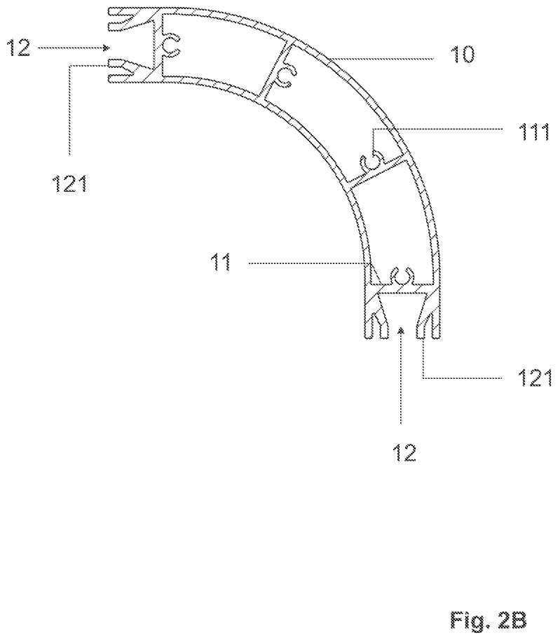

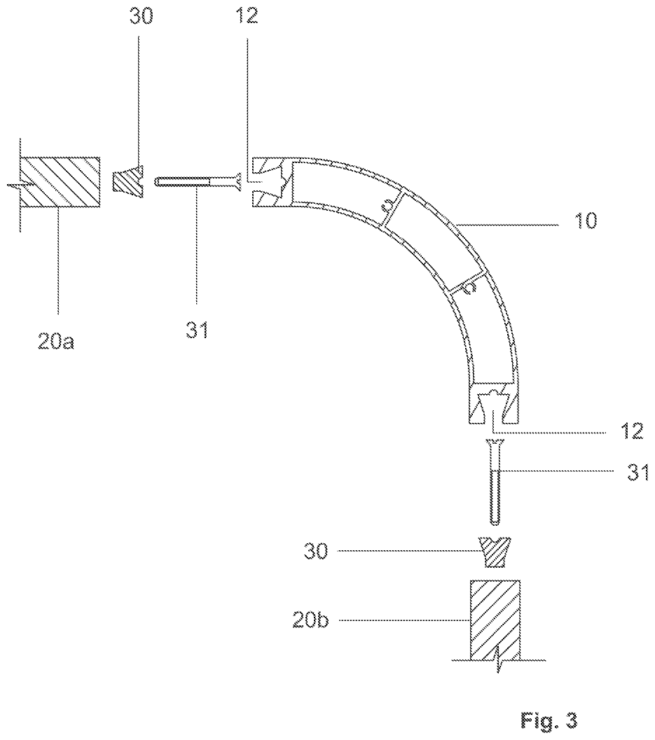

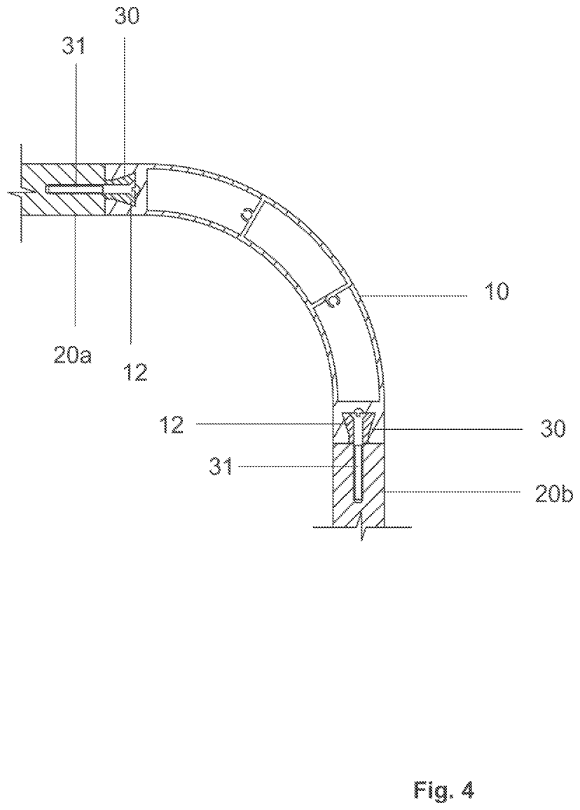

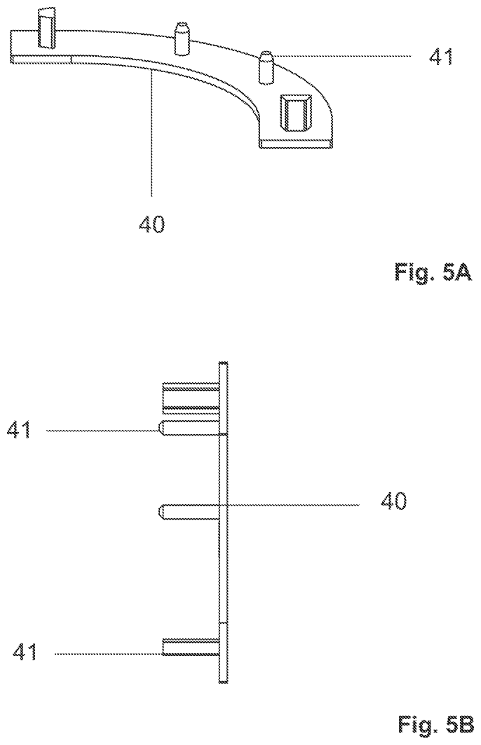

As presented in FIG. 2A the connector (10) is composed of a sole body with two free ends that are placed next to the side faces of plates, and hollowed side faces with structuring walls (11) equipped with fitting members. A linear recess with front opening and hollowed ends (12) is placed on the free ends of the connector (10), such linear recess (12) with an edge featuring opening restriction (121).

A pin (30) is fixed by means of a bolt (31) on the side faces of plates (20a), (20b) or (20c) contacting the end of the connector (10), and the pin's free end (30) is larger than opening's restriction area (121).

The pin (30) fixed on the sides of plates (20a), (20b) or (20c) is fitted into the linear recess (12) formed in the connector's free ends (10), such (30) sliding on the linear recess (12). Because of the shape of the linear recess (12), the pin (30) is fitted on the end of the recess (12) and slides freely on the linear recess (12), such pin (30) being retained in the restriction area (121) placed on the edge of the linear recess (12).

A lid of the same size as the connector (40) includes a flat structure that features orthogonal projections (41) on the inner side coinciding with the fitting members (111) placed in the connector's hollowed region (10), such orthogonal projections (41) engaged by means of interference with the fitting elements (111). When the lid (40) is placed and fixed on the connector's side (10), it prevents the pin (30) from sliding on the linear recess (12), thus locking the connector (10) on plates (20a), (20b) or (20c), eliminating slacks and ensuring the structuring and finishing of the piece.

Optionally, as presented in FIG. 2B, the connector features an elastic flange (122) on the edge with opening restriction (121) which yields to deformation and returns to its initial position once the mechanic intervention ceases, thus facilitating entry into the pin end (30), but not yielding to its passage when inserted into the linear recess (12).

The connector (10) allows for the multifunctionality and customization of the set, providing opportunity for altering the plates (20a), (20b) or (20c), of lids (40) and connectors (10), which may feature variations in textures and colors, among others, allowing for countless aesthetic combinations, apart from making the dismantling process easier, without damaging the structures, ensuring the formation of drawer chests, closets, center tables, bedside tables, corner tables, shelves, liquor cabinets, shoe cabinets, wardrobes, television racks, benches, tool boxes, working desks, writing desks, buffets, sideboards, among others.

1. MULTIFUNCTIONAL FURNITURE MODULE including:
a) a connector (10) with two free ends where a linear recess is placed (12) with a front opening with opening restriction (121) and hollowed ends, and hollowed side faces with structuring walls (11) equipped with fitting members (111);
b) a lid of the same size as the connector (40) equipped with a flat structure that features orthogonal projections (41) on the inner side coinciding with the fitting members (111) placed in the connector's hollowed region (10);
C) plates (20a), (20b) or (20c), on whose side a pin (30) is fixed by means of a bolt (31), such free end of the pin (30) being larger than the opening restriction area (121) of the connector's (10) linear recess (12), such pin (30) engaged and sliding on the linear recess (12) formed on the free ends of the connector (10).
